(19) United States
(12) Patent Application Publication
(10) Pub. No.: US 2009/0071561 A1
(43) Pub. Date: Mar. 19, 2009

(54) Method and system for improving gas flow in a duct or pipe

(76) Inventors: Dennis Dalrymple, Georgetown, TX (US); Jonas Klingspor, Austin, TX (US)

Correspondence Address: KLAUBER & JACKSON, 411 HACKENSACK AVENUE, HACKENSACK, NJ, 07601, US

(21) Appl. No.: 12/283,300

(22) Filed: Sep. 10, 2008

Related U.S. Application Data
(60) Provisional application No. 60/993,698, filed on Sep. 12, 2007.

(51) Int. Cl. F15D 1/02

(52) U.S. Cl. 138/44; 138/37; 137/8; 138/39

(57) ABSTRACT

A method for smoothing the gas flow profile in a duct or pipe in a system wherein the average gas velocity is greater than ten feet per second, comprising positioning within the duct or pipe and across the gas flow, a perforated plate wherein the openings thereof are hexagonal in shape, enabling the use of smaller holes than would otherwise be achievable with the use of round holes for the same pressure drop across the plate, which results in a higher degree of gas velocity profile smoothing for a given pressure drop across the plate.

### RELATED APPLICATION

This application claims priority from U.S. provisional patent application Ser. No. 60/993,698, filed on Sep. 12, 2007.

### FIELD OF INVENTION

This invention relates generally to smoothing gas velocity distribution in ducts and pipes, and more specifically relates to the use of perforated plates to achieve a more even velocity profile.

### BACKGROUND OF INVENTION

Gas flowing in ducts and pipes frequently exhibits uneven velocity distribution across the duct or pipe, with eddy currents and backflow often being observed. In power plants and chemical processing equipment it is often desirable to have an even gas velocity profile such as when the gas stream is subsequently being processed in a contacting device or a mist eliminator or when corrosive liquids exist downstream and backflow in the duct or pipe can result in excessive corrosion of the duct or pipe.

A common approach to smoothing the velocity profile and preventing backflow is to position a perforated plate across the flow in the duct or pipe, typically consisting of a flat plate with circular holes. The effect of the perforated plate is to distribute the gas more evenly across the plate since the pressure drop across an individual hole is proportional to the square of the velocity of the gas flowing through the hole so the gas molecules will tend to flow to holes with less flow until all the holes have approximately the same flow. As a result, the gas on the downstream side of the perforated plate will have a more uniform velocity profile.

Generally, the degree of velocity profile smoothing is a function of the pressure drop through the perforated plate with higher pressure drops resulting in more even velocity profiles downstream of the perforated plate. However, there are two general areas where the common approach of inserting a perforated plate with round holes does not result in a satisfactory outcome. The first general area where perforated plates with round holes are not satisfactory occurs in cases where the available pressure drop in the system for the perforated plate is relatively low, for example, less than two inches of water gauge, and the average gas velocity in the duct or pipe is greater than approximately ten feet per second. By “available pressure drop” is meant the pressure drop across the perforated plate that is tolerable when one takes into consideration the remaining pressure drops which are incurred in the system in order to perform its essential functions. In this case using perforated plates with round holes can often not produce an acceptable degree of velocity profile smoothing since the round hole size or diameter must be so large to avoid a pressure drop of two inches of water gauge or greater that there are not enough holes over a given plate area to adequately smooth the velocity profile.

The second general area where perforated plates with round holes are not satisfactory occurs in cases where there is adequate available pressure drop in the system for a perforated plate with round holes to adequately smooth the gas velocity profile and the gas velocity is greater than approximately ten feet per second. In this case the amount of pressure drop introduced by a perforated plate with round holes is so great that a substantial economic penalty results from the increased operating costs arising from the energy lost by the system as a result of the pressure drop across the perforated plate, and potentially also because of the increased capital costs due to the need for larger or incremental equipment to raise the system pressure back up to where there is sufficient pressure remaining downstream of the perforated plate for the equipment located there to perform adequately, such as to have adequate pressure to push the gas through sieve trays in gas treatment towers.

### SUMMARY OF INVENTION

In the present invention, a perforated plate with a different hole type is used, which results in smaller holes for a given total open area, enabling acceptable gas velocity smoothing to be achieved at a lower pressure drop than would be achievable with round holes. Alternately, use of this different hole type results in a lower pressure drop than would be incurred with round holes in cases where the round holes can achieve adequate velocity profile smoothing. In a typical example the present invention can be used to smooth the velocity profile of a sulfur-containing flue gas entering a scrubbing tower in a flue gas desulfurization (“FGD”) unit where the flue gas is contacted with calcium carbonate slurry and the total pressure drop available for the system is relatively small. However the present invention is not limited to use with any specific type of gas treatment tower or other processing equipment; thus it can be used anywhere gas is flowing through a duct or pipe with an uneven velocity profile and an even velocity profile is desired, but the amount of pressure drop available for such smoothing is limited and use of perforated plates with round holes is uneconomical or infeasible. This applicability of this invention is particularly important where average gas velocities greater than ten feet per second occur in the duct or pipe.

### BRIEF DESCRIPTION OF DRAWINGS

The invention is diagrammatically illustrated, by way of example, in the drawings appended hereto, in which:

FIG. 1 is a schematic plan view of a perforated plate with 74% open area, wherein conventional round openings are provided, such plate being illustrative of plates used in the prior art for smoothing gas flow in ducts or pipes:

FIG. 2 is a schematic plan view similar to FIG. 1, and again showing a perforated plate with 74% open area, but showing use in the plate of hexagonally formed openings, the plate being of the type used in the present invention;

FIGS. 3 and 4 are perspective views, schematic in nature, of the perforated plates of FIGS. 1 and 2, each being installed in a rectangular duct through which a gas flows;

FIG. 5 is a graphical depiction which illustrates the outlet gas profile found via Computational Fluid Dynamics (“CFD”) modeling where the two perforated plates of FIGS. 3 and 4 are placed in a 2 foot wide by 2 foot tall duct as illustrated in those Figures; and

FIG. 6 is a schematic diagram showing a typical location of a perforated plate as in FIGS. 2 and 4, being used for velocity profile smoothing in a flue gas desulfurization (“FGD”) unit, where a sulfur-containing flue gas enters a scrubbing tower where the flue gas is contacted with calcium carbonate slurry.

### DESCRIPTION OF PREFERRED EMBODIMENT

In accordance with the present invention a method and system is disclosed in which a perforated plate is used for smoothing the gas velocity profile in a duct or pipe, wherein the plate openings are hexagonal in shape, enabling a smaller hole size in the plate for a given total open area and pressure drop across the plate, thereby enabling use of the perforated plate in ducts and pipes with higher gas velocities. The openings are arranged in rows and columns on the plate and each hexagonal opening is oriented with respect to each of its neighboring hexagonal openings so that opposed flat sides of neighboring openings are parallel. Consequently the closed area of the plate defined between the flat sides of the neighboring openings is a continuous strip of constant width corresponding to the distance between the adjacent flat sides of neighboring openings.

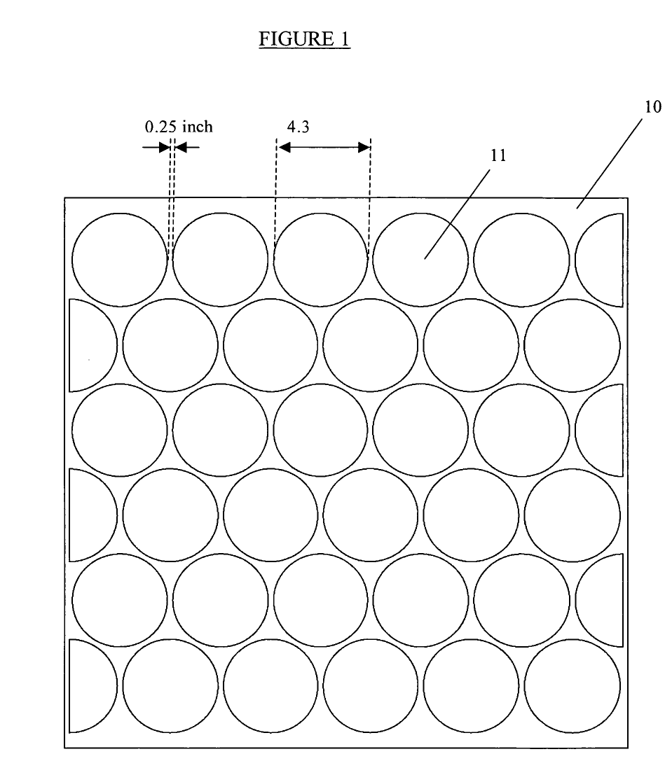

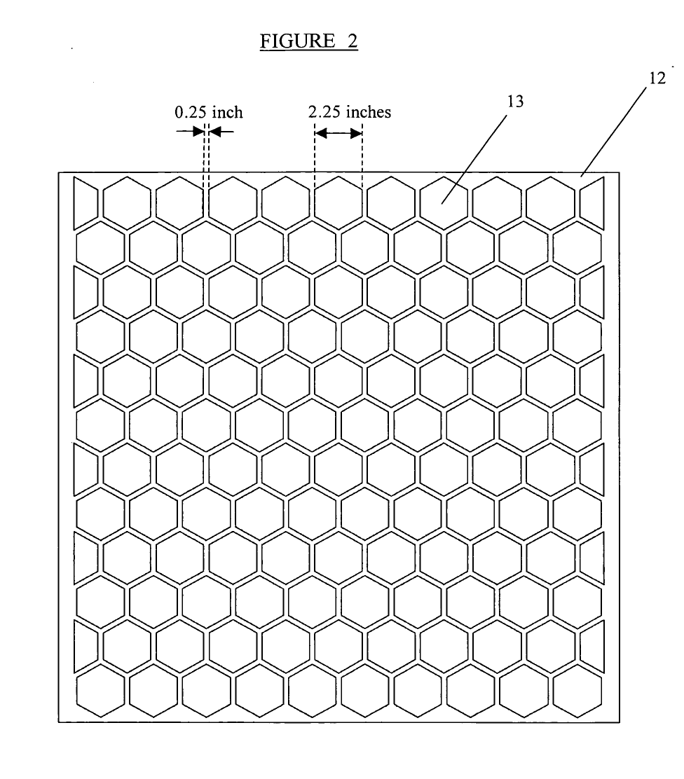

FIG. 1 schematically depicts the surface of a plate 10, which is provided with a plurality of conventional circular openings 11. Plate 10 has a 74% open surface and is of a type that has been used in the prior art to effect smoothing of the flow velocity profile in ducts and the like. FIG. 2 schematically depicts the surface of a perforated plate 12 as used in the present invention. Plate 12 is provided with a plurality of hexagonal openings 13 and with the same 74% open surface as plate 10. In both cases the same 0.25 inch minimum spacing between openings is utilized, but to achieve a 74% open surface with the conventional circular openings of plate 10 a 4.3 inch diameter circular opening is required, while with plate 12 and its hexagonal openings a flat side to flat side distance of only 2.25 inches is required. It will be appreciated that the dimensions shown in FIGS. 1 and 2 and just discussed, are merely set forth to enable comparisons, and are not intended to delimit the present invention.

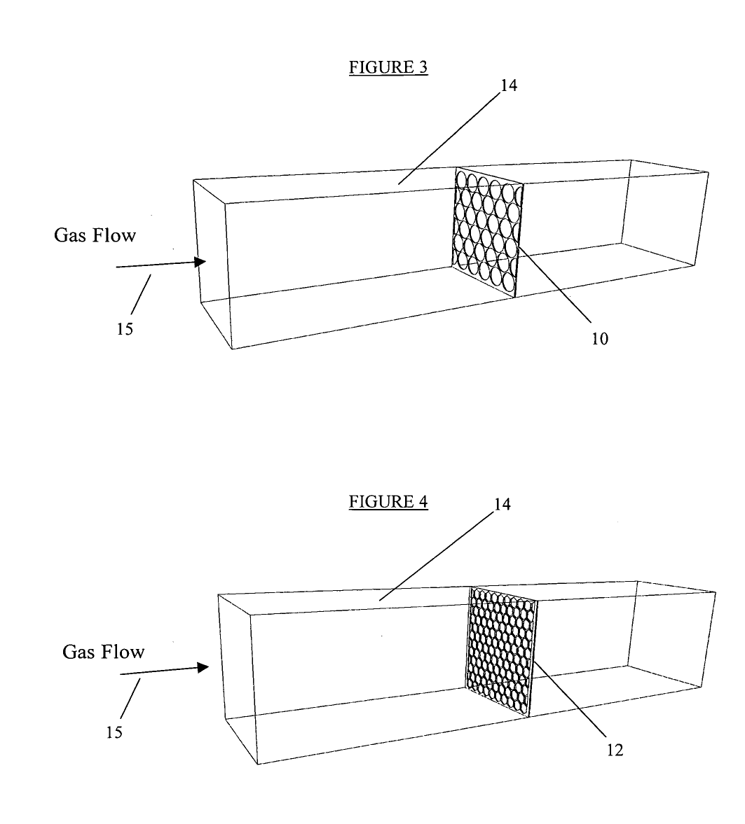

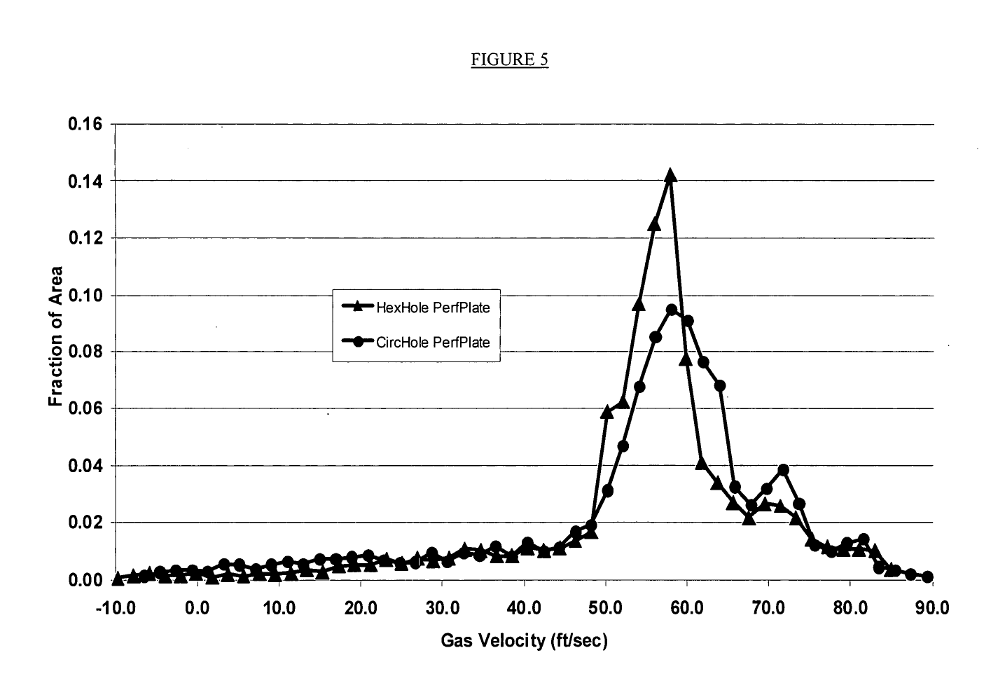

FIGS. 3 and 4 are perspective views, schematic in nature, of the perforated plates 10 and 12 of FIGS. 1 and 2, each being installed in a rectangular duct 14 through which a gas 15 flows. Referring to FIG. 5, Computational Fluid Dynamics (“CFD”) modeling of these two perforated plates when placed in and across a 2 foot wide by 2 foot tall duct as illustrated in FIGS. 3 and 4, validated that the velocity profile of the gas downstream of the plate with the hexagonal holes is substantially more even than the profile from the plate with the circular holes. For both cases, the gas used in the CFD analysis was typical exhaust gas and the average gas velocity was 54.7 foot per second. Both perforated plates were 0.25 inches thick and both cases produced a pressure drop of 0.5 inches of water gauge. The improved gas velocity smoothing result for the perforated plate 12 embodying the subject invention is shown by the much higher peak on the curve representing plate 12 than is seen in the curve representing plate 10. This is primarily a result of the fact that the individual hexagonal holes of plate 12 are substantially smaller than the corresponding circular holes of plate 10 for the same flowing pressure drop, and there are substantially more hexagonal holes than circular holes, thus distributing the gas more evenly across the plate with hexagonal holes as it flows through these holes.

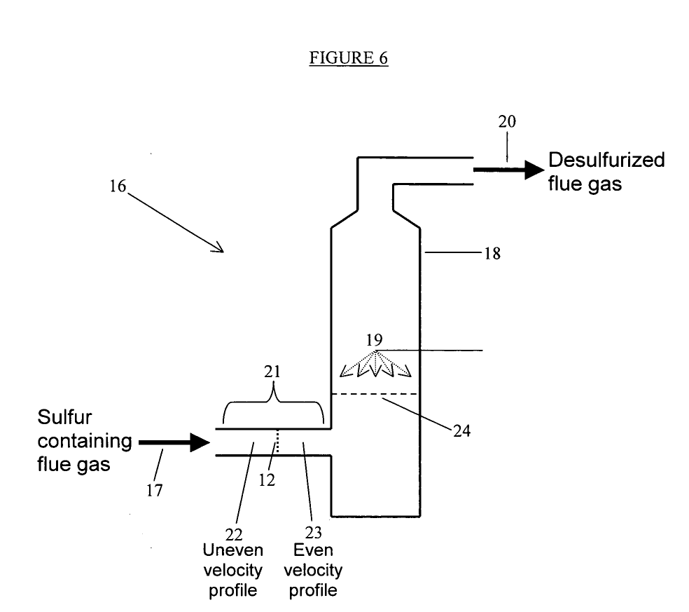

FIG. 6 is a schematic diagram showing a typical environment wherein a perforated plate 12 as in FIGS. 2 and 4 is used for velocity profile smoothing. The component 16 illustrated is part of a flue gas desulfurization (“FGD”) unit, where a sulfur-containing flue gas 17 enters a scrubbing tower 18 where the flue gas is contacted with a counter flowing calcium carbonate slurry 19 and emerges as desulfurized flue gas 20. The perforated plate 12 is typically placed in the gas inlet duct 21 at the base of the scrubbing tower 18 to smooth the uneven velocity profile 22 of the inlet gas at the upstream side of plate 12 so it is more evenly distributed in the duct at the downstream side 23 and thereby across the sieve tray 24. One advantage of this is that the corrosive calcium carbonate slurry flowing down from the sieve tray is less apt to enter the gas inlet duct 21 due to swirling and backflow areas in the gas flowing through the inlet duct to the base of the tower.

While the present invention has been particularly set forth in terms of specific embodiments thereof, it will be understood in view of the present disclosure, that numerous variations on the invention are now enabled to those skilled in the art, which variations yet reside within the scope of the present teaching. For example, an enhancement of the preferred embodiment is to round the intersections of the flat sides of the hexagonal holes thereby increasing the structural strength and integrity of the plate without appreciably degrading its gas velocity profile smoothing characteristics. Such rounding helps avoid stress cracking at the juncture of the flat sides and need only involve a few percent of the length of a given flat side, for example 5%, to achieve this benefit.

Accordingly, the invention is to be broadly construed and limited only by the scope and spirit of the disclosure and of the claims now appended hereto.

1. A method for smoothing the gas flow profile in a duct or pipe wherein the average gas velocity is greater than ten feet per second, comprising positioning across the gas flow within the duct or pipe, a perforated plate wherein the openings thereof are hexagonal in shape, enabling the use of smaller holes than would otherwise be achievable with the use of round holes for the same pressure drop across the plate, which results in a higher degree of gas velocity profile smoothing for a given pressure drop across the plate.

2. A method in accordance with claim 1, wherein the available pressure drop for the plate to achieve adequate velocity profile smoothing is less than two inches of water gauge.

3. A method in accordance with claim 1, wherein the said openings are arranged in rows and columns on said plate, each hexagonal opening being oriented with respect to each of its neighboring hexagonal openings so that opposed flat sides of said neighboring openings are parallel, whereby the closed area of said plate defined between the flat sides of said neighboring openings is a continuous strip of constant width corresponding to the distance between the adjacent flat sides of neighboring openings.

4. A method in accordance with claim 3, wherein said hexagonal openings have rounded intersections of the flat sides involving no more that five percent of any side thereby increasing the structural strength and integrity of the plate without materially compromising the gas velocity profile smoothing benefits of said hexagonal openings.

5. In combination with a duct or pipe through which a gas is made to flow, a perforated plate positioned in the duct or pipe across the gas flow for gas velocity profile smoothing, wherein the perforations in said plate are openings which are hexagonal in shape, enabling the use of smaller holes than would otherwise be achievable with the use of round holes for the same pressure drop across the plate, which results in a higher degree of gas velocity profile smoothing for a given pressure drop across the plate.

6. The combination of claim 5, wherein the said openings are arranged in rows and columns on said plate, each hexagonal opening being oriented with respect to each of its neighboring hexagonal openings so that opposed flat sides of said neighboring openings are parallel, whereby the closed area of said plate defined between the flat sides of said neighboring openings is a continuous strip of constant width corresponding to the distance between the adjacent flat sides of neighboring openings.

7. The combination of claim 6, wherein said hexagonal openings have rounded intersections of the flat sides involving no more that five percent of any side thereby increasing the structural strength and integrity of the plate without materially compromising the gas velocity profile smoothing benefits of said hexagonal openings.

8. The combination of claim 6, wherein the gas flow in said duct or pipe is such that available pressure drop for said plate to achieve adequate velocity profile smoothing is less than two inches of water gauge and the average gas velocity is greater than ten feet per second, such that the gas velocity profile smoothing would not be adequate if said openings were round.

9. The combination of claim 6, wherein the gas flow in said duct or pipe is such that the available pressure drop for said plate to achieve adequate velocity profile smoothing is two inches of water gauge or greater and the average gas velocity is greater than ten feet per second, whereby use of a perforated plate with conventional round holes would introduce a pressure drop so great as to result in substantial economic penalty arising from increased operating costs from the energy lost by the system and potential capital costs for equipment to raise the system pressure back up to where there is sufficient pressure remaining downstream of the plate for the equipment located there to perform adequately.
